(19) United States
(12) Patent Application Publication
(10) Pub. No.: US 2010/0121606 A1
(43) Pub. Date: May 13, 2010

(54) Measuring of geometrical parameters for a wind turbine blade

(75) Inventor: Jorgen Dahl Vestergaard, Kibaek (DK)

Correspondence Address: Mollborn Patents, Inc., 2840 Colby Drive, Boulder, CO, 80305, US

(73) Assignee: LM GLASFIBER A/S, Kolding (DK)

(21) Appl. No.: 12/597,978

(22) PCT Filed: Apr. 21, 2008
(86) PCT No.: PCT/DK08/00145

§ 371 Date: Nov. 13, 2009

(30) Foreign Application Priority Data
Apr. 30, 2007 (DK) PA2007/00647

(51) Int. Cl. G01B 11/24

(52) U.S. Cl. 702/167

(57) ABSTRACT

This invention relates to methods for measuring geometrical parameters of a wind turbine blade, the method comprising placing a surveying instrument with a view to the root of the blade and measuring the blade. Methods are described for measuring parameters such as the blade length, the blade bending, the twist and the alpha-angle of the blade. This is accomplished by the use of a surveying instrument by which is measured a number of points or markings on the root of the blade, the blade tip and/or some reference markings on the blade. The invention further relates to the use of a surveying instrument for measuring and/or marking geometrical parameters on a wind turbine blade and for measuring deformations of a wind turbine blade.

The present invention relates to methods for measuring geometrical parameters and characteristics of a wind turbine blade.

### BACKGROUND

Most wind turbines are equipped with a number of blades which at least theoretically are identical. This is important in order to ensure symmetrical loadings exerting on all the mechanical components in the nacelle such as the shaft, the hub, gears, bearings and the like. Similarly, in the case of forward bending blades, all the blades on the same turbine must be pre-bended to the same extent. This is important because otherwise the one blade bending more up into the wind than the others will tend to decelerate the others a little which again leads to unequal loads and a non-optimal power extraction for the wind turbine.

However, although all due care is taken during manufacture and handling of the blades, although the blades are manufactured from the same moulds using the same materials and tools etc, some variations on the exact final geometry from one blade to another are unavoidable. These product variations arise among other factors from changes in temperature and humidity during curing of a blade, creep, and from human factors. It is therefore important to measure the final shape and geometry of each blade and determine how and how much it deviates from the blade design. This both with a view towards improving the manufacturing process to achieve a more perfect agreement between the blade model and the final blade and in order to group the blades so. that the most similar blades are used on the same turbine, or so that the differences among the blades can be compensated for when mounting the blades.

The very large structure of a modern wind turbine blade (60 m long or more) naturally imposes certain problems on the measuring of the geometrical parameters.

Traditionally, the pre-bending of a blade is measured by placing the blade on even ground in a specific position, holding a plumb line to the blade tip and taking aim from the root. However, this is a very inaccurate method which is highly dependent on the person taking the measurement, the positioning of the blade and how it is supported.

Another important geometrical parameter of a wind turbine blade is the amount of twist, i.e. the difference in pitch between the blade root and the blade tip and, perhaps more importantly, how the twist for a specific profile (the so-called alpha-angle) for a specific blade is related to the exact positions of the root bushings. The alpha-angle is then used to compensate for any possible difference in the twist relative to the blade model by pre-setting the pitching mechanism accordingly for that individual blade. The twist is traditionally measured by the use of a template for that specific type of blade. The template is equipped on one side with a surface matching the model blade profile on a certain position. The template is then positioned on the finished blade on its specific position where it fits. The angling of the template is then measured from the reading of an inclinometer placed on the template, which measurement is then transferred to the root of the blade. This method is, however, unfavorable as the measuring is unavoidably associated with great uncertainties arising mainly from the imprecise placing and holding of the template on the profile and because of the procedure being manual and with the reasons to errors this gives.

### OBJECT AND SUMMARY OF THE INVENTION

It is therefore an object of the present invention to propose methods for measuring geometrical parameters of a wind turbine blade which at least partly overcome the problems of high degrees of accuracy outlined above.

According to one aspect the present invention relates to a method for measuring geometrical parameters of a wind turbine blade, the method comprising placing a surveying instrument with a view to the root of the blade and measuring the blade. As also mentioned in the introduction, geometrical parameters of a wind turbine blade comprise characteristics relating to the geometry of the blade such as the blade length and bending, the exact positions of the bushings and the twist of the blade. By the use of a surveying instrument such as a total station, the relatively large inaccuracies (arising at least partly from the large dimensions of a wind turbine blade) and absolute measures of the blade parameters can be obtained. The proposed method is advantageous by providing a simple, inexpensive and fast method of obtaining absolute and/or relative measures of a blade which can be performed at any time or anywhere suitable without any special preparations necessary. For instance, the measuring can be performed while the blade is waiting for transport or is on stock which is advantageous as the measuring then does not necessarily have to be performed in the production hall taking up both time and space. Furthermore, the measuring method is contact-free wherefore the measuring in itself will not inflict the blade by forces from equipment or personnel. The method is also advantageous in not requiring any special fixture for the blade or the surveying instrument. The measuring method according to the above can also be performed partly automated, thereby diminishing the human sources of errors. Using a surveying instrument also makes it possible to perform the measurements with very high accuracies, and the method hereby proposes an effective means for control of precision of the production to see if the final wind turbine blades meet the specifications.

In an embodiment said method further comprises placing the surveying instrument with a view to the root and the tip of the blade, measuring the position of at least two points on the root plane of the blade and determining the root plane of the blade.

In an embodiment said method further comprises determining the center of the root by measuring at least two points on the root of the blade with approximately equal distance from the root center.

In an embodiment said method further comprises determining the center line of the blade from said root plane and said root center.

In a further embodiment said method further comprises measuring the position of the tip of the blade and determining the distance from said tip of the blade to said center line of the blade, thereby determining the bending of the blade.

In an embodiment said method further comprises measuring the position of the tip of the blade and determining the length of the blade.

In an embodiment said method further comprises turning the blade approximately 90 degrees, repeating said measurements and re-determining said geometrical parameters compensating for the gravity forces.

According to another aspect the present invention relates to a method according to the above further comprising placing a surveying instrument with a view to a number of reference markings on the blade and measuring said number of reference markings on the blade.

In yet a further embodiment said method comprises placing the blade with its trailing edge vertically and determining the angle between horizontal and a line through said reference markings, thereby determining the twist of the blade.

In still a further embodiment said method comprises measuring a number of root reference points on the blade and determining the angle between a line through said reference markings and a line through said root reference points, thereby determining the twist of the blade.

A further embodiment of the invention concerns the method according to the above further comprising comparing said twist of the blade with the twist of the blade as designed, thereby determining the product variation of the blade. Hereby also a better comprehension of how a large composite structure such as the wind turbine blade changes in shape while curing can be obtained.

In an embodiment said method further comprises marking said twist on the root of the blade by the surveying instrument. By letting the surveying instrument point to where the marking for the twist (which in a special case is equal to the alpha-angle) should be on the blade, a better precision on the marking is obtained.

According to another aspect the present invention relates to a method according to the above further comprising placing a surveying instrument with a view to one or more markings on the blade such as e.g. drainage holes, lightning receptors, diverter strips, and measuring said markings on the blade.

According to yet another aspect the present invention relates to a method according to the above further comprising placing a surveying instrument with a view to one or more reference markings on the blade, subjecting the blade to loads and measuring said markings on the blade, thereby determining the deformation of the blade. Hereby is obtained a very simple, yet accurate method for determining the deformations of the blade when subjected to different load situations.

The above mentioned measurement methods are furthermore advantageous in that the way the measuring on the blade itself is independent of the specific blade type so that the same procedure can be performed on all blades requiring no special adaptation from one blade to the next.

According to another aspect the present invention relates to the use of a surveying instrument for measuring geometrical parameters of a wind turbine blade. The advantages are here as described previously.

In yet another aspect the present invention relates to the use of a surveying instrument for the marking of geometrical parameters on a wind turbine blade.

In yet a further aspect the present invention relates to the use of a surveying instrument for measuring geometrical parameters of a mould for a wind turbine blade. Hereby is obtained means for acquiring data yielding more directly the relations between the parameters of the wind turbine blade as designed, during the production, and the final manufactured blade (the product variation). This is important in order to be able to improve the agreement between the blade model and the final blade.

Finally, the present invention relates to the use of a surveying instrument for the measuring of deformations of a wind turbine blade. The advantages are here as mentioned previously.

### BRIEF DESCRIPTION OF THE DRAWINGS

In the following preferred embodiments of the invention will be described referring to the figures, where

FIG. 1 illustrates the surveying method for measuring the length and bending of a wind turbine blade seen in a perspective view,

FIG. 2 shows the flapwise and edgewise components of the bending of the blade tip as seen in a plane perpendicular to the center line of the blade,

FIGS. 3 and 4 illustrate the surveying method on a wind turbine blade as seen from the blade root and placed with the trailing edge upwards and to one side, respectively,

FIGS. 5 and 6 illustrate the surveying method for measuring the twist of a wind turbine blade seen in a perspective view and on the root plane, respectively,

FIG. 7 illustrates another embodiment of the surveying method for measuring the twist of a wind turbine blade, and

FIG. 8 illustrates the use of a surveying instrument for measuring on a mould for a wind turbine blade.

### DESCRIPTION OF PREFERRED EMBODIMENTS

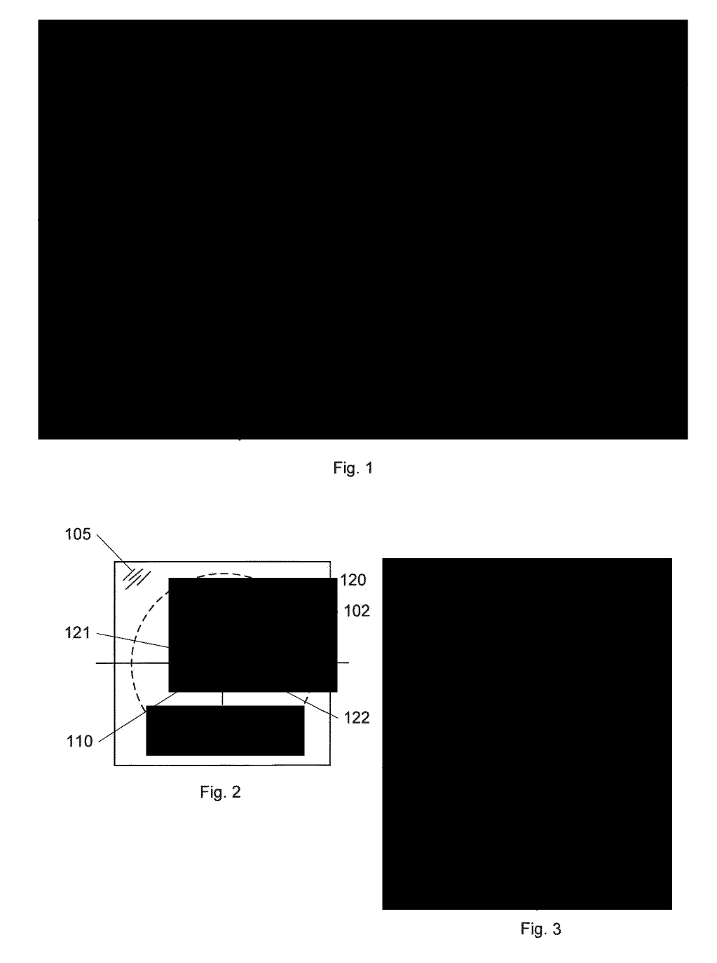

FIG. 1 illustrates a blade 100 for a wind turbine as seen in a perspective view. In this case the blade is placed with its trailing edge upwards, but the measurements described in the following could equally well be performed with the blade placed in other positions. A surveying instrument 101 is placed with an unobstructed view to the tip of the blade 102 and to the blade root 103 as illustrated by the lines of sight 104.

The surveying instrument 101 could for instance comprise basic traditional tools for surveying such as a tape measure, a level, a theodolite set on a tripod and/or a total station, the latter being a combination of an electronic theodolite (transit), an electronic distance measuring device (EDM) and software running on an external computer. Some total stations even no longer require a reflector or prism to return distance measurements, they are fully robotic and can connect to satellite positioning systems such as a Global Positioning System (GPS). In one embodiment of the invention a servo driven total station with laser pointer is used. With a servo driven surveying instrument the instrument can also be set to automatically point out points of interest for marking, etc. With a total station the angles and distances from the instrument to the points to be surveyed are determined. With the aid of trigonometry the angles and distances are used to determine the coordinates of actual positions (X, Y and Z or northing, easting and elevation) of the surveyed points. When it here and in the following is described that the surveying instrument measures some point, this expression therefore also covers the case of the surveying instrument actually measuring distances and angles to said point from which the position of the point can be derived directly.

Accuracies of a surveying instrument of 5″ both horizontally and vertically (which equals ±2 mm on 75 m) and ±(2 mm+2 ppm) on the distance meter are normal. The surveying instrument is advantageously connected directly to a computer for processing the measured data. A direct connection gives the user the opportunity to start the proposed software directly and create the necessary report, etc. along the way.

When having placed the surveying instrument 101 the length and the bending of the blade (in this case the pre-bending which for some blade types can be quite considerable) can be determined. In one embodiment this is done by measuring the tip of the blade 102 and a number of points on the root of the blade 103 which are used to determine the root plane 105 and the root center point 110 of the blade. If the blade is placed so that the root plane 105 is vertical or approximately vertical within an acceptable accuracy, only two points 106, 107 on the root are needed to define the root plane 105. Otherwise a third point 108 (or more) is needed. In order to determine the root center point 110 the two points in the root are chosen to be in the center of two root bushings 109 which are supposedly placed the same distance away from the root center 110. Alternatively, one can use two other points with known or equal distance to the root center, such as points on the exterior or interior rim of the blade flange 122, etc.

If a surveying instrument with a servo driven laser pointer is employed, a placing of the blade with a putative vertical root plane 105 can be controlled and verified by first measuring the two points on the blade root 106, 107 and then letting the surveying instrument point to a third point on the vertical plane the same distance away from the root center. Hereby the assumption of vertical placement can be verified or corrected by visual inspection.

Having determined the root center 110 and the root plane 105 the center line 111 of the blade is placed (perpendicular to the root plane and passing through the root center). Using then the blade tip point 102, the following geometrical parameters of the blade can be determined by using simple geometrical relations: the distance from the root center point 110 to the tip of the wing 102, the distance from the root center point 110 to the tip of the wing 102 along the center line 111 of the blade which is also the length 112 of the blade, and the offset from the center line 111 to the tip of the wing 102 expressing the absolute bending of the blade 120. The bending 120 of a wind turbine blade is often also specified by its flapwise 122 and edgewise 121 components. If the trailing edge is placed vertically as sketched in FIG. 1, the flapwise component 122 is also the horizontal distance from the blade tip 102 to the center line 111. This is also illustrated for clarity in FIG. 2 where the position of the blade tip 102 is depicted as seen directly in from the root plane 105.

These measurements on the wind turbine blade are also illustrated in FIG. 3 where the wind turbine blade for the sake of clarity is sketched as seen from the root and a little above.

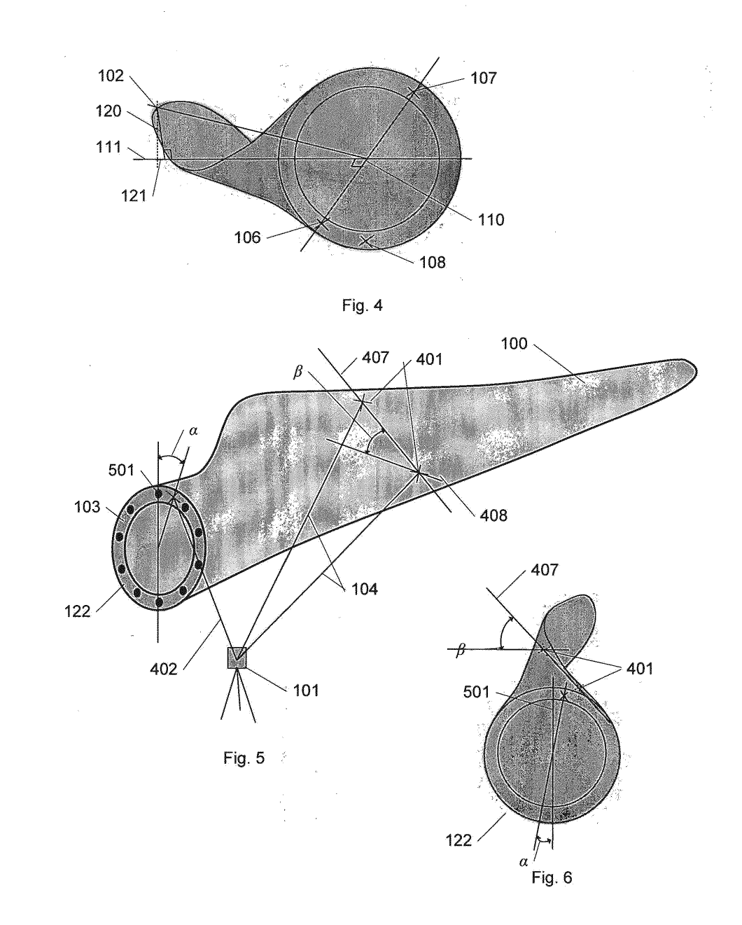

In order to account for the gravity forces acting on the blade and to take into account the way the blade might be supported leading to inaccurate determinations of the geometrical parameters, the measurements are advantageously repeated with the turbine blade in a new position. In one embodiment the blade is rotated approximately 90° around its length and placed with the trailing edge to one side. This is illustrated in FIG. 4 where the blade is depicted as seen from the root and a little to one side. The surveys described above are then repeated where after the geometrical parameters for the wind turbine can be determined with a better accuracy where also the deformations from the gravity forces can be accounted for. If the surveying is performed with the trailing edge positioned vertically, the measurement of the flapwise component 122 of the blade bending can with high accuracy be regarded as being independent of the gravity forces. Similarly, the edgewise component 121 of the blade bending determined with the trailing edge placed horizontally (as illustrated in FIG. 4) is only influenced minimally, if at all, from the gravitational forces.

FIG. 5 illustrates a method according to the invention for measuring the twist of a wind turbine blade 100 using a surveying instrument. As described above, a surveying instrument 101 is placed with a view to the root 103 of the blade and to some reference markings 401 placed at some pre-defined positions down the blade.

Such reference markings 401 can in one embodiment comprise small projections or protrusions appearing as a result of corresponding protrusions or projections, respectively, made in the mould for the wind turbine blade and via the moulding process transmitted to the final blade. In this easy and simple way a number of reference points or markings with known relative positions on the blade are ensured. Markings can also appear by differences in the reflection properties, material or color variations, etc. These types of markings can also be transferred from the corresponding positions in the mould and onto the finished blade, e.g. by polishing the mould locally (leaves a shining spot on the blade) or by embedding a pointer in a different material and/or another color exteriorly in the blade at the desired positions.

In a simple embodiment of the invention the blade 100 is placed on the ground or in its supporting devices with the trailing edge positioned vertically as sketched in FIGS. 5 and 6. The two reference markings 401 are measured, and the angle β of the line 407 passing through the reference points 401 in relation to horizontal 408 is determined. The size of this actual measured angle β is compared against the size of the same angle according to the model and design parameters of the blade, the difference between the two being a measure of how much the actual final twist of the manufactured blade deviates from the twist according to blade design. This difference is then usually accounted for simply by pre-setting the pitching mechanism accordingly for that individual blade. In order to facilitate such a pre-setting the so-called alpha-angle α, which is defined as the twist in a specific pre-defined profile, is marked directly on the flange 122 of the blade either in writing and/or by marking the angle α in relation to a specific bushing 501 (for instance the bushing placed where the pitch is zero according to the blade design or as is often the tradition in relation to the first bushing left of vertical) or the like. If the surveying instrument 101 comprises a laser pointer the alpha-angle α can be marked 402 directly on the root flange 122 of the wind turbine blade in the same working operation as the measuring of the geometrical parameters of the blade.

In one embodiment the two reference markings 401 are made in the same section and profile of the blade so that the angle β is equal to the twist of the blade. In a further embodiment of the invention the reference markings 401 are further placed in the specific profile defined for the alpha-angle so that the measured angle β is equal to the alpha-angle α. Also, an intended positioning of the reference markings in the same profile could be controlled and verified by measuring up against the center line 111 of the blade as determined previously.

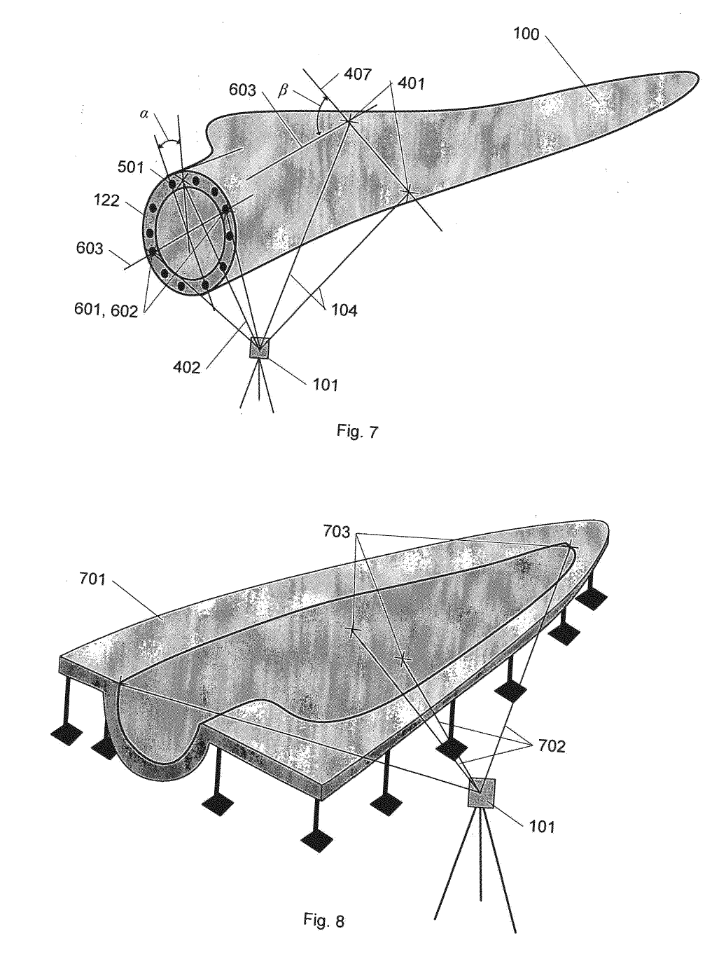

According to another embodiment of the method the measuring is independent of how the blade is positioned on the ground or in its supports (i.e. if the trailing edge is upwards, etc). In addition to measuring the reference markings 401 as described above, the surveying instrument 101 is also used to measure the positions of one or more root reference points 601 on the root of the blade which points yield directly or indirectly the zero-pitch setting of the blade. A set of root reference points 601 could in one embodiment comprise the positions of two reference bushings 602 placed where the pitch-angle is 90° opposite each other on each side of the flange 122 as illustrated in FIG. 7. From these measurements the angle β, of the line 407 through the two reference markings 401 in relation to the line 603 through the two root reference points 601, is determined. The size of this angle β then again yields how much the blade is actually twisted and, by comparison to the design values, also how much the assumed zero-pitch setting if off from the actual zero-pitch setting of the blade and the alpha-angle α. As described above, the alpha-angle α can then also optionally be marked on the blade flange 122 for an easier pre-adjustment of the blade pitch when the blade is mounted on a nacelle.

As described above, both the measuring of the blade length, pre-bending and twist can be carried out in one step by simply placing the surveying instrument as described close to the flange of the wing in a way that provides sight to all the points on the wing. Here the root reference points 601 can also be used as the root point 106, 107 used in defining the root plane. The necessary points for the geometrical parameters wanted are then measured and the data are downloaded to a connected computer which then can perform the calculations of dimensions and the marking data of the alpha-angle and make a report. The surveying instrument can then (if equipped with a laser pointer or the like) be set to automatically point to the point for marking of the alpha-angle (or any other geometrical parameter).

In a further embodiment a bigger number of reference markers (for instance 10 or even 100) are placed or marked on the blade all along the same cross section of the blade marking out an entire profile of the blade at a certain position. Hereby the exact profile of the finished blade at the given position can then be measured using the surveying instrument similarly to the previously described, whereby a precise measure of the product variations from the designed to the final manufactured blade is obtained by simple means.

In much the same way as the surveying instrument 101 can be used to measure the wind turbine blade, the instrument could also advantageously be used to measure and control the geometrical parameters of the rather huge moulds 701 used to manufacture the blades. This is illustrated in FIG. 8. Here a surveying instrument 101 is placed with lines of sight 702 to a number of reference points 703 different places in the mould 701. Hereby the actual physical dimensions and geometrical parameters of the mould can be verified up against the design of the blade type to be made and eventually corrected if needed.

Apart from the bending, the length and twist of the blade, the surveying instrument could also be used to measure, verify, control and/or mark other markings and physical parameters of the blade such as for instance the exact position of a drainage hole, a diverter strip, lightning receptors or areas that are to be painted, etc. The method could also advantageously be used to measure the deformations of the blade when subjected to different test loadings. A common feature of the above is that it is a great advantage that the surveying instrument can easily be moved around, does not require any fixtures or the like, does not take up much space and is easy to operate.

It should further be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word ‘comprising’ does not exclude the presence of other elements or steps than those listed in a claim.

1. A method for measuring geometrical parameters of a wind turbine blade, the method comprising placing a surveying instrument with a view to the root of the blade and measuring the blade.

2. A method according to claim 1, further comprising
placing the surveying instrument with a view to the root and the tip of the blade,
measuring the position of at least two points on the root plane of the blade, and
determining the root plane of the blade.

3. A method according to claims 1-2, further comprising
determining the center of the root by measuring at least two points on the root of the blade with approximately equal distance from the root center.

4. A method according to claim 3, further comprising
determining the center line of the blade from said root plane and said root center.

5. A method according to claim 4, further comprising
measuring the position of the tip of the blade,
determining the distance from said tip of the blade to said center line of the blade, thereby determining the bending of the blade.

6. A method according to claim 4, further comprising
measuring the position of the tip of the blade,
determining the length of the blade.

7. A method according to claims 1-6, further comprising
turning the blade approximately 90°,
repeating said measurements,
re-determining said geometrical parameters, compensating for the gravity forces.

8. A method according to claim 1, further comprising
placing a surveying instrument with a view to a number of reference markings on the blade, and
measuring said number of reference markings on the blade.

9. A method according to claim 8, further comprising
placing the blade with its trailing edge vertically, and
determining the angle between a line through said reference markings and horizontal, thereby determining the twist of the blade.

10. A method according to claim 8, further comprising
measuring a number of root reference points on the blade, and
determining the angle between a line through said reference markings and a line through said root reference points, thereby determining the twist of the blade.

11. A method according to claims 9-10, further comprising
comparing said twist of the blade with the twist of the blade as designed, thereby determining the product variation of the blade.

12. A method according to claims 10-11, further comprising
marking said twist on the root of the blade by the surveying instrument.

13. A method according to claim 1, further comprising
placing a surveying instrument with a view to one or more markings on the blade such as e.g. drainage holes, lightning receptors, diverter strips, and
measuring said markings on the blade.

14. A method according to claim 1, further comprising
placing a surveying instrument with a view to one or more reference markings on the blade,
subjecting the blade to loads, and
measuring said markings on the blade thereby determining the deformation of the blade.

15. Use of a surveying instrument for measuring geometrical parameters of a wind turbine blade.

16. Use of a surveying instrument for the marking of geometrical parameters on a wind turbine blade.

17. Use of a surveying instrument for measuring geometrical parameters of a mould for a wind turbine blade.

18. Use of a surveying instrument for the measuring of deformations of a wind turbine blade.
